(19) United States
(12) Patent Application Publication
(10) Pub. No.: US 2019/0385603 A1
(43) Pub. Date: Dec. 19, 2019

(54) SYSTEM AND METHOD OF ACOUSTICALLY CONTROLLING EQUALIZER IN NATURAL LANGUAGE AND COMPUTER READABLE STORAGE MEDIUM

(71) Applicant: Tymphany Acoustic Technology (Huizhou) Co., Ltd., Huizhou City (CN)

(72) Inventors: Yick Hong Lam, Huizhou City (CN); Yeap Yau Lin, Huizhou City (CN); Banghao Xu, Huizhou City (CN); Xudong Liu, Huizhou City (CN); Li Wei, Huizhou City (CN)

(21) Appl. No.: 16/443,228

(22) Filed: Jun. 17, 2019

(30) Foreign Application Priority Data
Jun. 15, 2018 (CN) 201810621160.6

(51) Int. Cl. G10L 15/22; G10L 15/30; G06F 3/16; G10L 15/26

(52) U.S. Cl. CPC G10L 15/22; G10L 15/30; G10L 2015/223; G10L 15/265; G06F 3/165

(57) ABSTRACT

A method of acoustically controlling an equalizer in a natural language includes receiving a speech; performing automatic speech recognition; outputting a text message corresponding to the speech; obtaining a digital signal processing parameter of the corresponding text message from a database according to the text message; and adjusting the equalizer according to the digital signal processing parameter. The method may be implemented on a computer readable storage medium storing executable software.

### CROSS REFERENCE TO RELATED APPLICATIONS

This application claims priority under 35 U.S.C. § 119 to Chinese Patent Application No. CN 201810621160.6, which was filed on Jun. 15, 2018, and which is herein incorporated by reference.

### TECHNICAL FIELD

The present invention relates to an equalizer adjustment method and a computer readable storage medium, in particular to a method of acoustically controlling an equalizer in a natural language and a computer readable storage medium.

### BACKGROUND

In general, if a tone (Tone) of sound played by a loudspeaker is desired to be adjusted, various parameters, such as technical specifications including frequency band, frequency, gain, intensity and delay time, of the equalizer need to be carefully adjusted, and the loudspeaker can be controlled to play the sound with a specific effect. However, the inventor has recognized that the aforementioned process of adjusting the parameters of the equalizer is difficult for general consumers to understand and master the relevant acoustic technical definitions or causes faulty operation.

### SUMMARY

In view of this, some embodiments of the present invention propose a method of acoustically controlling an equalizer in a natural language and a computer readable storage medium suitable for adjusting the equalizer.

In one embodiment, the method of acoustically controlling the equalizer in the natural language includes receiving a speech; performing automatic speech recognition, and outputting a text message corresponding to the speech; obtaining a digital signal processing parameter of the corresponding text message from a database according to the text message; and adjusting the equalizer according to the digital signal processing parameter.

In one embodiment, the equalizer can change the volume intensity/gain value corresponding to a frequency/frequency band after being adjusted.

In one embodiment, the speech is received by a wireless input device.

In one embodiment, the database is accessed by a network application to obtain the corresponding digital signal processing parameter.

In one embodiment, automatic speech recognition is performed by the network application.

According to another aspect of the invention, a system for controlling an equalizer is provided, the system comprising at least an audio device comprising or connectable to a microphone, wherein the system is configured to carry out a method according to the invention. In one embodiment, the computer readable medium stores a computer program, and the method of any one of the above embodiments is implemented when the computer program is executed by a processor.

The objects, the technological contents, the characteristics and the efficacy of the present invention would be more easily understood with detailed description of the following particular embodiments in connection with the attached drawings.

### BRIEF DESCRIPTION OF DRAWINGS

FIG. 1 is a schematic diagram showing an equalizer adjustment method of one embodiment of the present invention.

FIG. 2 is a schematic diagram showing an equalizer adjustment architecture of one embodiment of the present invention.

FIG. 3 is a schematic diagram showing an equalizer adjustment architecture of one embodiment of the present invention.

FIG. 4 is a schematic diagram showing an equalizer adjustment architecture of one embodiment of the present invention.

FIG. 5 is a schematic diagram showing an equalizer adjustment architecture of one embodiment of the present invention.

### DETAILED DESCRIPTION

The embodiments of the present invention will be described in detail below with reference to the drawings. In addition to the detailed description, the present invention may be widely practiced in other embodiments, and any alternatives, modifications and equivalent variations of the described embodiments are included in the scope of the present invention and are subject to the scope of the patent. In the description of the specification, numerous specific details are set forth in order to provide a thorough understanding of the present invention for a reader; and however, the present invention may be still implemented on the premise of omitting a part or all of the specific details. In addition, well-known steps or components are not described in detail in order to avoid unnecessarily limiting the present invention. The same reference numbers will be used throughout the drawings to denote the same or like parts. It is specifically noted that the drawings are for illustrative purposes only and do not represent the actual size or number of components.

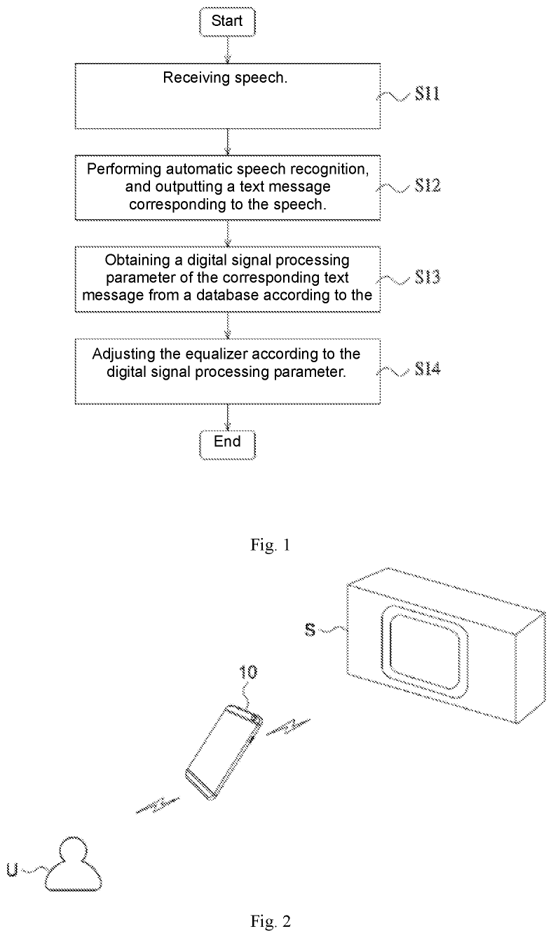

Referring to FIGS. 1 to 3, an embodiment, referring to the method of acoustically controlling the equalizer in the natural language, of the present invention will be described below. First of all, the method of the present invention can be implemented by executing software, and furthermore, a method of acoustically controlling the equalizer in the natural language can be implemented by utilizing a mobile phone application (APP).

FIG. 1 illustrates the method according to an exemplary embodiment of the invention. The method includes receiving a speech (S11). In one embodiment, the user U speaks to provide a daily spoken language as the aforementioned speech. For example, the daily spoken language is used for describing the sound effect or tonality that the user U desires to achieve, such as, but not limited to, lifelike expressions, including warm tone, brightness, dryness, wetness, miriness, sharpness, blues, buzzing, hollowness or rhinolalia, easy to understand. Therefore, the user U does not need to have a professional equalizer knowledge or an acoustic technical background to propose a natural language requirement and, thus, effectively adjust the equalizer. In one embodiment, the user U speaks to an audio device 10, such as, but not limited to, a mobile phone. That is, the method of the present invention may receive the speech from the user U through a microphone 12 built in the mobile phone (audio device 10).

In another embodiment, receiving the speech from the user U may also be performed through other input devices, such as a wireless headset. The wireless headset transmits the speech received by the microphone to the audio device 10 through a Bluetooth. The audio device 10 can be not only the mobile phone but also a computer speech.

The audio device 10 is provided with an automatic speech recognition unit 30, whereby a calculation unit 20 of the audio device 10 controls the automatic speech recognition unit 30 to execute automatic speech recognition and output a corresponding text message of the speech (S12). For example, the automatic speech recognition unit 30 may be an automatic speech recognition software downloaded from a network and is stored in a memory of the mobile phone or the computer (audio device 10), and the automatic speech recognition is further executed when the software application of the present invention is executed. Therefore, when the user U speaks “warm”, the automatic speech recognition unit 30 automatically recognizes a content of the speech and outputs the text message equivalent to “warm” in substantial sense. In addition, the step of outputting the corresponding text message may be implemented by, for example, but not limited to, the computer speech recognition (CSR) unit or a speech to text recognition (STT) unit. Alternatively, a natural language processing (NLP) unit can be used to extract the required parameters from the lifelike expressions and convert the natural language into a more easily processed form of the computer program. For example, parameters “warm”, “increase” and the like can be extracted from sentences such as “want to hear warmer sounds” and “warmer” through a Dialogflow software from google. Therefore, compared with the CSR and the STT, the NLP can handle a wider recognition condition, rather than only recognizing specific keywords.

Next, the calculation unit 20 receives the text message returned by the automatic speech recognition unit 30 and transmits the text message to the database 40, thereby obtaining a digital signal processing (DSP) parameter 42 of the corresponding text message according to the database 40 (S13). In the embodiment, the database 40 is also stored in the audio device 10.

Wherein the database 40 records multiple different digital signal processing parameters 42 and corresponding lifelike expressions thereof, that is, the database 40 is a database for storing the text messages and the corresponding digital signal processing parameters 42 thereof.

In some embodiments, the digital signal processing parameters 42 are one, several, a group of or multiple groups of parameters and can determine the volume intensity/gain value corresponding to each frequency/frequency band when the equalizer performs broadcasting; for example, the corresponding digital signal processing parameter 42 of a phrase “warm tone” said by the user U represents that the volume intensity in the frequency range of 60 Hz to 250 Hz is increased by 5 dB; and for example, the corresponding digital signal processing parameter 42 of the phrase “less miry” represents that the volume intensity at the frequency of 500

In some embodiments, the digital signal processing parameters 42 are digital signal processing filter (DSP Filter) settings. The digital signal processing filtering effects include, but not limited to, the broadcasting effects including reverberation and echo; and for example, the corresponding digital signal processing parameter 42 of a phrase, that “I want a wet tone”, said by the user U represents addition of a reverb filter (Reverb Filter) setting. From the above, the user speaks the lifelike expressions to describe the desired sound effect or tonality and does not need to accurately say professional technical terms such as frequency, gain, delay time, etc., the digital signal processing parameters corresponding to different tonalities or sound effects can be set and returned, and then how to adjust the equalizer is explained below.

The calculation unit 20 adjusts the equalizer 50 according to the digital signal processing parameters 42 after receiving the digital signal processing parameters 42 returned by the database 40 (S14). The efficacy and the advantages of speaking the lifelike expressions by the user to acoustically control the equalizer 50 and the loudspeaker S are realized, the convenience and success rate of adjusting the equalizer 50 by general consumers are improved, and the faulty operation is reduced at the same time. The efficacy and the advantages of speaking the lifelike expressions by the user to acoustically control the equalizer 50 and the loudspeaker S are realized, the convenience and success rate of adjusting the equalizer 50 by general consumers are improved, and the faulty operation is reduced at the same time. In some embodiments, the automatic speech recognition unit 30 and the database 40 are both stored in the audio device 10 (for example, the computer or the mobile phone), so that the audio device 10 can directly execute the software for implementing the present invention without connecting to the network, and the method of the present invention can be achieved.

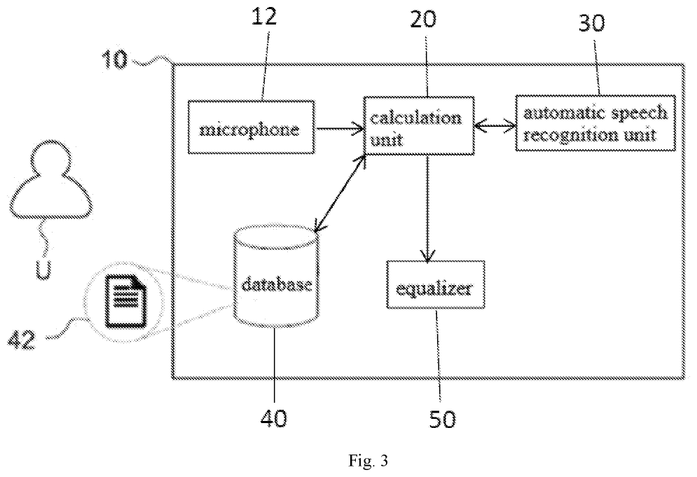

As a technology of cloud computing is evolved and popularized, the equalizer adjustment methods of some embodiments of the present invention are not limited to the implementation architecture shown in FIG. 3, and some related embodiments are described below.

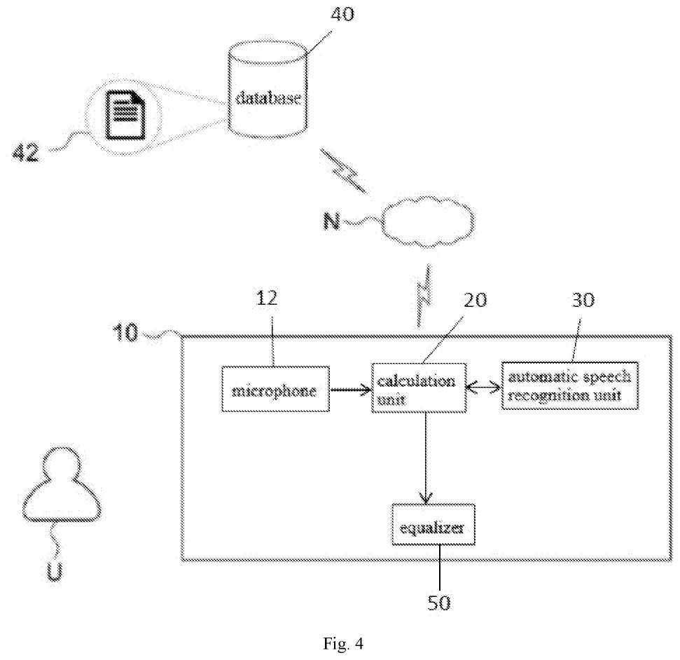

Referring to FIG. 1 together with FIG. 4, unlike the above various embodiments, the database 40 is not stored in the audio device 10, but is stored in the cloud, that is, the step of obtaining the digital signal processing parameter 42 of the corresponding text message from the database 40 needs to be connected to the cloud through other network applications. In the embodiment, when the software for implementing the present invention is executed, the audio device 10 needs to be connected to the network before accessing the database 40. In addition, other execution steps are the same and are not repeated herein.

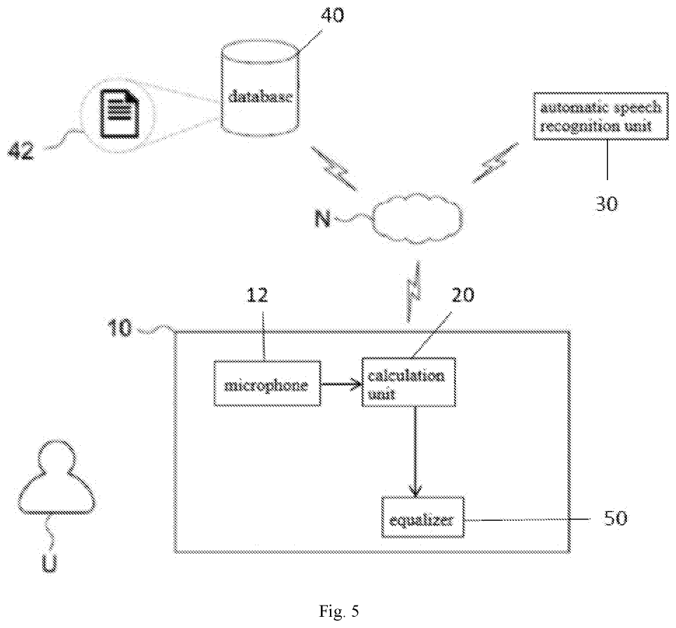

Referring to FIG. 1 together with FIG. 5, unlike various embodiments described above, the database 40 and the automatic speech recognition unit 30 are not stored in the audio device 10 but in different clouds. That is, the step of obtaining the digital signal processing parameter 42 of the corresponding text message from the database 40 is connected to the cloud through other network applications, and in addition, the step of executing the automatic speech recognition is also connected to the cloud through different network applications. In the embodiment, when the software for implementing the present invention is executed, the audio device 10 needs to be connected to the network before accessing the database 40 and performing automatic speech recognition. In addition, other execution steps are the same and are not repeated herein. From the above, the illustrated equipment devices or the application programs of the audio device 10, the calculation unit 20, the automatic speech recognition unit 30, the database 40, the network N and the like in the architectures shown in FIGS. 3-5 are not intended to limit the aspects of the embodiments of the present invention. The method of acoustically controlling the equalizer in the natural language of at least one embodiment of the present invention can be implemented by different permutations, a person skilled in the art can perform modifications and variations self, and the present invention is not limited thereto.

According to certain exemplary embodiments of the invention, a computer readable storage medium is provided, wherein a computer program is stored thereon. For example, the computer readable storage medium is an optical disc, a flash drive, a non-transitory memory storage device or a network server, but not limited to this. It should be noted that downloading the application (APP) on the network to the mobile phone is to store the application in the non-transitory memory storage device of the mobile phone. The computer readable storage medium can be loaded by a processor of the computer to perform the method of acoustically controlling the equalizer in the natural language. The detailed steps and the related embodiments have been described above and will not be repeated herein.

In summary, for the method of acoustically controlling the equalizer in the natural language and the computer-readable storage medium according to some embodiments of the present invention, the user can use the daily spoken language without accurately saying, for example, professional technical terms including frequency, gain and delay time, and the digital signal processing parameters corresponding to different tonalities or sound effects can be set and returned, so that the equalizer is correctly adjusted, the efficacy and advantages of speaking the lifelike expressions by the user to acoustically control the equalizer are realized, the convenience and success rate of adjusting the equalizer 50 by the general consumers are improved, and the faulty operation is reduced at the same time.

The above described embodiments are merely illustrative for the technical characteristics and concepts of the present invention, the objectives are that those skilled in this art could understand the content of the present invention and implement therefrom, limitation to the patent scope of the present invention cannot be made only by this embodiment, that is to say, any equivalent variations or modifications in accordance with the spirit disclosed by the present invention shall be contemplated as being within the patent scope of this invention.

1. A method of acoustically controlling an equalizer in a natural language, comprising:
receiving a speech;
performing automatic speech recognition;
outputting a text message corresponding to the speech;
obtaining a digital signal processing (DSP) parameter of the text message from a database according to the text message; and
adjusting the equalizer according to the digital signal processing parameter.

2. The method according to claim 1, wherein the equalizer is configured to change a volume intensity/gain value corresponding to a frequency/frequency band after being adjusted.

3. The method according to claim 1, wherein said receiving the speech comprises receiving the speech through a wireless input device.

4. The method according to claim 1, wherein said obtaining the digital signal processing parameter comprises accessing the database through a network application to obtain the digital signal processing parameter.

5. The method according to claim 1, wherein said performing automatic speech recognition is performed by a network application.

6. A computer readable storage medium where a computer program is stored, wherein when the computer program is executed by a processor, the method according to claim 1 is implemented.

7. A system for controlling an equalizer, the system comprising:
an audio device comprising or connectable to a microphone,
wherein the system is configured to carry out the method according to claim 1.
